(19) United States
(12) Patent Application Publication
(10) Pub. No.: US 2014/0302858 A1
(43) Pub. Date: Oct. 9, 2014

(54) APPARATUS AND METHOD FOR ORIGINATING CALL BY SUBSTITUTE COMMUNICATION NETWORK WHEN ORIGINATING CALL IS BARRED

(71) Applicant: Pantech Co., Ltd, Seoul (KR)

(72) Inventors: Seung Woo NAM, Seoul (KR); Myeong Seon Seo, Seoul (KR); Sung Kyum Yoon, Seoul (KR)

(73) Assignee: Pantech Co., Ltd., Seoul (KR)

(21) Appl. No.: 14/222,131

(22) Filed: Mar. 21, 2014

(30) Foreign Application Priority Data
Apr. 5, 2013 (KR) 10-2013-0037674

(51) Int. Cl. H04W 36/22; H04W 4/16

(52) U.S. Cl. CPC H04W 36/22; H04W 4/16
USPC 455/445

(57) ABSTRACT

A portable terminal and a method for originating a call through a substituted network when originating a call is barred due to overload of a first network is disclosed herein. A call may be originated by automatically switching the communication mode of the portable terminal from the first network such as an LTE network to a second network such as a 3G network or a 2G network, when originating a call is barred in the first network. The information of the cell of the second network is searched from a second network database stored in advance, which allows the time to search for a cell and time to register in the second network decrease. The searched cell with the highest power level may be selected and the call is originated through the selected cell of the second network.

### CROSS-REFERENCE TO RELATED APPLICATION

This application claims priority from and benefit under 35 U.S.C. §119(a) of Korean Patent Application No. 10-2013-0037674, filed on Apr. 5, 2013, in the Korean Intellectual Property Office, which in its entirety is hereby incorporated by reference for all purpose as if fully set forth herein.

### BACKGROUND

1. Field

The following description relates to an apparatus and method for originating a call by substitute communication network when originating a call in a communication network is barred.

2. Discussions of Background

Long Term Evolution (LTE) is a term named after a next-generation communication technology evolving from the third-generation (3G) mobile communication. LTE is also referred to as 3.9 generation (3.9G) mobile communication as a technology positioned between the 3G mobile communication represented by a wideband code division multiple access (WCDMA), a code division multiple access (CDMA) 2000, etc. and the fourth-generation (4G) mobile communication, and is one of leading candidates for the 4G mobile communication technology.

Since an LTE network system is a data-dedicated network configured by an all-IP network, the LTE network system supports only a packet switching (PS) network but does not support a voice call that is transmittable through a circuit switching (CS) network. Thus, in order to support a voice service in the LTE network system, additional technology is necessary. The Voice over Long Term Evolution (VoLTE), acquired by profiling circuit switched fall back (CSFB) and IP multimedia subsystem (IMS), is currently a popular representative technology.

The VoLTE serves not only a data call but also a voice call through a PS network. When a considerably high load is applied to an LTE network base station to process large amounts of data calls, the LTE network base station additionally needs to process voice calls. Accordingly, in a region where many users are densely populated, due to overload of the base station, users may not be able to use not only a data call but also a voice call. For example, in a region where many users are densely populated, such as a football field or a concert hall, because one base station needs to process a large amount of data transmitted from a large number of portable terminals, calling services of some portable terminals may be barred. In such a case, some users may not be able to use any call originating services of their portable terminals.

The process in which originated calls are barred will be described more specifically with reference to FIG. 1.

In operation S10, a portable terminal is registered in an LTE network. After the portable terminal performs a cell search to search for a communicable base station, the portable terminal and the cell are synchronized with each other. After the synchronization, the portable terminal acquires a physical layer identity (ID) of the cell and searches for cell frame timing, whereby the portable terminal may be registered in the LTE network.

Thereafter, in operation S11, the portable terminal receives system information block 2 (SIB2) messages at regular time intervals. The SIB2 message includes cell information that is needed for a portable terminal to appropriately operate within a corresponding cell and necessary information for barring the call of a portable terminal belonging to the cell.

In operation S12, if an originating call barring message is present within the SIB2 message, the portable terminal stores the originating call barring message. An originating call barring message includes an ac-BarringInfo message, and the ac-BarringInfo message includes ac-BarringForEmergency, ac-BarringForMO-Signalling, and ac-BarringForMO-Data Information Element (IE). In addition, ac-BarringForMO-Signalling and ac-BarringForMO-Data IE include ac-BarringConfig IE, and ac-BarringConfig IE includes sub-IEs ac-BarringFactor, ac-BarringTime, and ac-BarringForSpecialAC. Here, ac-BarringFactor has numbers (for example, 0, 0.05, 0.1, and 0.15 to 0.95) within a range equal to or larger than zero and smaller than one, [0,1). In addition, ac-BarringTime has a value between 4 seconds to 512 seconds. When the portable terminal receives the SIB2 message, all the IE values within ac-BarringInfo are stored.

Thereafter, in operation S13, the portable terminal receives a request for originating a call from a user input. For example, the user inputs a text to the portable terminal and requests the transmission for sending a message. The portable terminal determines whether a VoLTE connection may be made to a corresponding cell based on the user's request for originating a call.

Specifically, in operation S14, the portable terminal checks whether the ac-BarringForMO-Data IE is present within the ac-BarringInfo message. When the ac-BarringForMO-Data IE is not present, in operation S18 the portable terminal tries to originate a call using the LTE cell.

However, in operation S15, if the ac-BarringForMO-Data IE is present, an access classes (AC) value stored in a USIM of the portable terminal is checked to determine whether the AC value has a value in the range of 11 to 15. If the AC value has a value in the range of 11 to 15, in operation S18 the portable terminal tries to originate a call using the LTE cell.

On the other hand, in operation S16, if the AC value has a value in the range of 0 to 9, the portable terminal checks if the difference between a random value and the ac-BarringFactor value is greater than zero. The random value represents a random number that is generated in the range of 0 to 1 at the same probability and is internally generated by the portable terminal.

If the difference in operation S16 is less than zero, in operation S18 the portable terminal tries to originate a call in a corresponding LTE cell. On the other hand, in operation S17 if the difference in S16 is greater than zero, originating a call from the portable terminal is barred in the corresponding cell. The barring of the originating call continues for a predetermined time at a specific probability until the ac-BarringForMO-Data IE is no longer received through the SIB2 message.

As described above, if a large number of users are densely populated within a specific cell, originating a call from a portable terminal by an arbitrary user within the cell may be barred. Since originating a call includes not only a data call but also a voice call, an arbitrary user within a cell where originating a call is barred may not use most of the data communication services.

### SUMMARY

Exemplary embodiments of the present invention provide an apparatus and a method for originating a call in a cell in a second network if originating a call in a first network is barred.

Additional features of the invention will be set forth in the description which follow, and in part will be apparent from the description, or may be learned by practice of the invention.

An exemplary embodiment of the present invention provides an apparatus including a reception unit to receive from a base station a message barring originating a call in a first network; a storage unit to store a first information, the first information being information of one or more cells of a second network included in a system information block (SIB) message; an input unit to receive a request to originate a call; a control unit to select a cell in the storage unit with a power level higher than a preset value if originating the call is barred in the first network; and a transmission unit to originate the call in the selected cell.

An exemplary embodiment of the present invention provides a method to originate a call including receiving from a base station a message barring originating a call in a first network; storing a first information, the first information being information of one or more cells of a second network included in a system information block (SIB) message; receiving a is request to originate a call; selecting a stored cell with a power level higher than a preset value if originating the call is barred in the first network; and originating the call in the selected cell.

An exemplary embodiment of the present invention provides an apparatus including a reception unit to receive from a base station a message barring originating a call in a first network; a storage unit to store a first information, the first information being information of one or more cells of a second network included in a system information block (SIB) message; an input unit to receive a request to originate a call; a communication mode switching unit to switch a communication mode from the first network to the second network if originating a call is barred in the first network; a cell searching unit to search for cells in the second network database and measure power levels of the searched cells; a cell selecting unit to select a searched cell if the power level of the searched cell is higher than a preset value; and a transmission unit to originate the call in the selected cell.

An exemplary embodiment of the present invention provides a method for including receiving from a base station a message barring originating a call in a first network; storing a first information, the first information being information of one or more cells of a second network included in a system information block (SIB) message; receiving a request to originate a call; switching a communication mode from the first network to the second network if originating a call is barred in the first network; searching for cells in the second network database and measuring power levels of the searched cells; selecting a searched cell if the power level of the searched cell is higher than a preset value; and originating the call in the selected cell.

It is to be understood that both the foregoing general description and the following detailed description are exemplary and explanatory and are intended to provide further explanation of the invention as claimed. Other features and aspects will be apparent from the is following detailed description, the drawings and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is flowchart illustrating a process in which originating a call is barred for a portable terminal belonging to an LTE cell according to the related art.

FIG. 2 is a structural diagram of a portable terminal according to an exemplary embodiment of the present invention.

FIG. 3 is a conceptual diagram of a 2G network or 3G network database stored in a storage unit according to an exemplary embodiment of the present invention.

FIG. 4 is a schematic diagram that illustrates the relationship between a portable terminal and a cell according to an exemplary embodiment of the present invention.

FIG. 5 is a flowchart that illustrates a method for originating a call through a second network according to an exemplary embodiment of the present invention.

FIG. 6 is a flowchart that illustrates a method of determining whether a call is originated through a substituted network according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Hereinafter, an apparatus and a method for originating a call through a second network when originating a call through a first network is barred according to an exemplary embodiment of the present invention will be described more detail with reference to the drawings.

The 3G mobile communication is also referred to as IMT2000, and includes technologies such as WCDMA, CDMA 2000, Time Division—Synchronous Code Division Multiple Access (TD-SCDMA), Digital Enhanced Cordless Telecommunications (DECT), Universal Wireless Commun-136 (UWC-136), and Mobile Worldwide Interoperability for Microwave Access (WiMAX). In addition, the second-generation (2G) mobile communication includes technologies such as Time Division Multiple Access (TDMA), Frequency Division Multiple Access (FDMA), Code Division Multiple Access (CDMA), Chemical Specialties Manufacturers Association (CSMA), Orthogonal Frequency Division Multiple Access (OFDMA), Space Division Multiple Access (SDMA), and Global System for Mobile communication (GSM). Specifically, the 3G and 2G mobile communication technologies such as WCDMA and GSM may be applied to an exemplary embodiment of the present invention.

The LTE network system includes VoLTE, which is a communication method acquired by profiling CSFB and IMS as discussed above. VoLTE has a frequency bandwidth wider than that of the 3G voice phone call and has superior call quality by using a high-quality voice codec. Accordingly, a call connect time is markedly shorter than that of 3G mobile communication system, and a voice phone call may be switched to a video phone call. In addition, a photograph, a video, position information, etc. may be easily shared during a voice phone call.

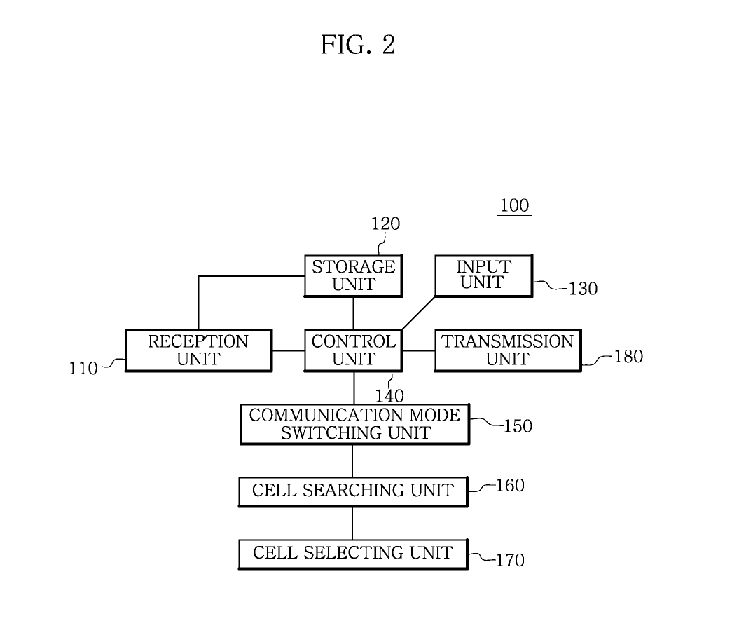

FIG. 2 illustrates a portable terminal 100 including a reception unit 110, a storage unit 120, a control unit 140, a communication mode switching unit 150, a cell searching unit 160, a cell selecting unit 170, an input unit 130, and a transmission unit 180, according to an exemplary embodiment of the present invention.

The reception unit 110 receives messages, information, etc. that are necessary to the communication of a portable terminal 100 from a base station. In order to provide a communication service in an arbitrary communication system, a physical channel for transmitting common information such as the configuration of a cell is necessary, and when a portable terminal 100 selects a specific cell, the portable terminal 100 may perform communication after receiving system information relating to the selected cell through the physical channel. The system information is included in a system information block (SIB) message and is transmitted through the physical channel.

Hereinafter, the different types of SIB messages will be described in more detail. An SIB1 message contains values of various timers, counters, etc. and information relating to a core network (CN). An SIB2 message contains an identifier of a URA (Universal Terrestrial Radio Access Network (UTRAN) Registration Area) to which the cell belongs, and the identifier includes an originating call barring message. For example, the originating call barring message includes an ac-BarringInfo message, and the ac-BarringInfo message includes ac-BarringForEmergency, ac-BarringForMO-Signalling, and ac-BarringForMO-Data IE. The ac-BarringForMO-Signalling and ac-BarringForMO-Data IE include an ac-BarringConfig IE, and the ac-BarringConfig IE includes sub-IEs, ac-BarringFactor, ac-BarringTime, and ac-BarringForSpecialAC. An SIB3 message contains information that is necessary to the selection of a cell and the reselection of a cell. An SIB4 message contains information that is necessary to the selection of a cell and the re-selection of a cell to be used by the portable terminal 100 that is in the connection mode. An SIB5 message contains information relating to common channel configured in a corresponding cell. An SIB6 message contains information relating to common channels of a corresponding cell to be used by the portable terminal 100 that is in the connection mode.

The storage unit 120 stores data for the operation of the portable terminal 100, including information relating to a cell of a second network, such as a 3G network and a 2G network that may substitute for the LTE network. Specifically, when the reception unit 110 receives the SIB2 message in which an originating call barring message is included, the storage unit 120 stores the originating call barring message. In detail, if ac-BarringInfo and ac-BarringForMO-Data are present within the SIB2 message, they may be stored in the storage unit 120. In addition, if the cell information of the second network adjacent to the location of the portable terminal 100 is included within the SIB6 message received by the reception unit 110, the storage unit 120 may store such cell information. Furthermore, the storage unit 120 may store the information of a cell used when the portable terminal 100 had been previously registered in the second network. In detail, the information of a cell that has been previously used may be the information of a 3G network or a 2G network the portable terminal had been previously registered in before being registered in the LTE network.

The storage unit 120 may store the cell information supplied from the SIB6 and the information of a cell that has been previously used in a second network database to manage the cell information. The second network database may include, for example, a 3G network database and a 2G network database, and cell information corresponding to each network is stored in the corresponding database. Managing the databases relating to the cell information of the second networks decreases time required to search for a cell and time to register to a second network by increasing the probability of finding a desired cell at the time of searching for a cell in which a call may be originated while cells that may be registered in the networks are separately managed.

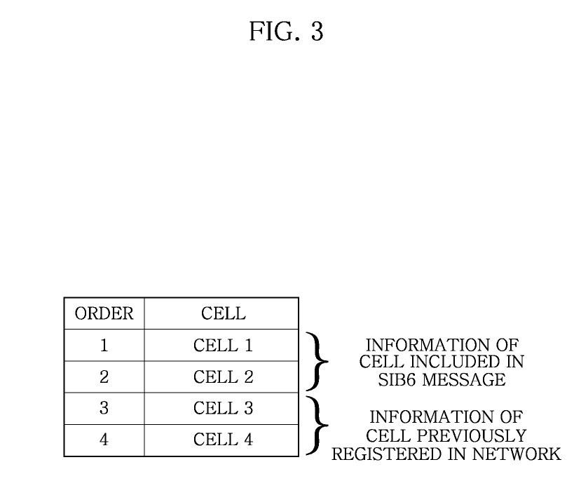

FIG. 3 illustrates the conceptual structure of the second network database including, for example, the 3G network database or the 2G network database. As illustrated in FIG. 3, in the second network database, a plurality of cell information pieces are formed as a list. For example, the cell information pieces may be stored or identified as into cell information included in the SIB6 message and the information of cells used by the portable terminal 100 in previously registered networks. The cell information stored in the second network database is ranked in a descending order of the power of each cell. For example, information of cell 1 and cell 2 included in the SIB6 message and information of cell 3 and cell 4 which are cell information of previously registered networks may be stored as a list as illustrated in FIG. 3. If cell 1 has the highest power level, followed by cell 2, cell 3, and cell 4, the cell information of the corresponding cells may be stored in the corresponding order. In FIG. 3, although the cell information included in the SIB6 message is ranked at the top, aspects need not be limited thereto such that the cell information included in the SIB6 message may be ranked lower than some or all of the cells and, for example, may be ranked at the bottom if it has the lowest power level.

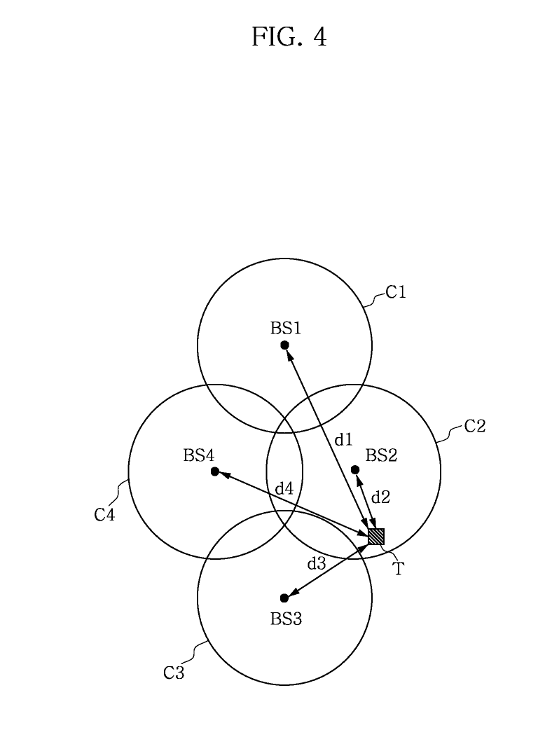

The power of a cell will be described in more detail with reference to FIG. 4. Each cell includes the base station. For example, a cell C1 includes a base station BS1, a cell C2 includes a base station BS2, a cell C3 includes a base station BS3, and a cell C4 includes a base station BS4. Each of the base stations BS1, BS2, BS3, and BS4 propagates signals with, generally, a constant power level, and accordingly, the range, on the ground, of influence of one cell may be a circle shape. If a portable terminal T is located in a specific location within the second cell C2, distances between the portable terminal T and the base stations BS1, BS3, and BS4 of cells C1, C3, and C4 may differ from each other. The power of a cell influencing the portable terminal T decreases as the portable terminal T is located farther from the base station of the cell, and the power of the cell influencing the portable terminal T increases as the portable terminal T is located closer to the base station of the cell. As illustrated in FIG. 4, for example, the distances from the portable terminal T to the base stations BS1, BS2, BS3, and BS4 of the first cell C1, second cell C2, third cell C3, and fourth cell C4, are defined as distance d1, distance d2, distance d3, and distance d4 respectively. As shown in FIG. 4, the distance d2 between the portable terminal T and the base station BS2 of the cell C2 is the shortest followed by distances d3, d4, and d1. Accordingly, the second cell C2 has the highest power level for the portable terminal T, followed by the third cell C3, the fourth cell C4, and the first cell C1.

As the power of a cell influencing a portable terminal 100 becomes higher, the reception sensitivity of the portable terminal 100 is improved, and each database of the storage unit 120 stores cell information in order of the highest to lowest power level of the cells. Accordingly, in the second network database, information of, for example, the 3G network cell and the 2G network cell are listed in a descending order of the power levels of the cells. Although described sometimes as being separate, aspects need not be limited thereto such that the 3G network cells and the 2G network cells and other network cells may be included in one database and listed in a descending order of power level of the cells regardless of to which network or technology the cell belongs.

The input unit 130 in FIG. 2 receives a user input requesting for originating a call. The input unit 130 may be configured in the form such as a keypad, a button, or a touch screen. For example, when a user clicks on a phone call icon displayed on the touch screen, a request for originating a voice call is input to the portable terminal 100.

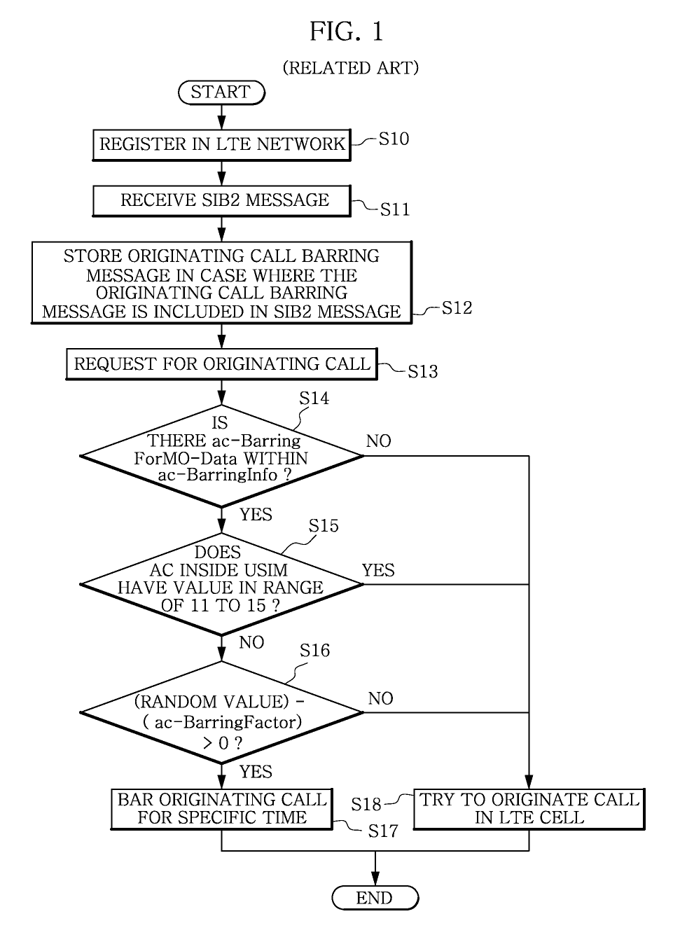

The control unit 140 in FIG. 2 determines whether a call may be originated in accordance with the input of the request for originating a call. As described in S14, S15, and S16 illustrated in FIG. 1, the control unit 140 determines whether there is an originating call barring message, checks whether the AC value is within a range in which a call may be originated, and determines whether the difference between a random value and the ac-BarringFactor is higher than zero, thereby determining whether originating a call is barred. If originating a call is determined to be barred, the control unit 140 bars originating a call for a specified time.

If originating a call is barred, the control unit 140 may search for a cell communicable through the second network. The control unit 140 checks the communicability of the second network through the communication mode switching unit 150, the cell searching unit 160, and the cell selecting unit 170, to be described in more detail, and originates a call through the searched cell communicable through the second network. Meanwhile, if a cell communicable through the second network is not retrieved through a search, the control unit 140 may return to the LTE network and re-search for a communicable cell.

The communication mode switching unit 150 switches between the communication modes of the LTE network and the second network such as the 2G network or the 3G network in the portable terminal 100. If originating a call is barred in the LTE network, the communication mode switching unit 150 switches the communication mode by selecting one of the 2G network and the 3G network. The communication mode switching unit 150 switches the communication mode to a different second network if a call may not be originated in the selected second network. Specifically, the communication mode switching unit 150 switches the communication mode first to a 3G network if originating a call is barred in the LTE network, and switches the communication mode to a 2G network if communication in the 3G network may not be performed. If communication may not be performed through the second network as well, the communication mode switching unit 150 switches the communication mode from the substituted second network to the LTE network. The communication mode switching unit 150 is controlled by the control unit 140 and may be included in the control unit 140. Although aspects are described as being part of the control unit 140, aspects need not be limited thereto such that the communication mode switching unit 150 may be included separately or within other components or units.

The cell searching unit 160 in FIG. 2 searches for a cell of the second network, which is stored in the second network database, or searches for a cell of the second network for the entire frequency band and measures the power for the cell of the second network that is retrieved through the search. The cell searching unit 160 measures the power for the cell of the second networks to connect the portable terminal 100 to a cell having the highest power level and reception sensitivity. Although the power may be measured for the entire frequencies of all of the second networks, the cell searching unit 160 first measures the power for a stored cell if the cell information is stored in the second network database. Although described as connecting the portable terminal 100 to a cell having the highest power level and/or reception sensitivity, aspects need not be limited thereto such that the portable terminal 100 may be connected to a cell having a sufficient power level and/or reception sensitivity such as, for example, a power level and/or a reception sensitivity greater than a threshold power level and/or reception sensitivity.

Although the power levels may be measured for all of the frequencies of the corresponding second networks, this may delay the time for searching for a cell having a highest power level. Thus, according to an exemplary embodiment of the present invention, by using the second network database stored in advance, the time required for searching for a cell may be shortened. In the second network database, while the cell information is arranged in the order of highest to lowest power levels, because the cell information was stored before originating a call was barred, the power levels of the cells may have changed according to the movement of the portable terminal 100. Therefore, according to an exemplary embodiment of the present invention, the power of the cells stored in the second network database is measured again by the cell searching unit 160 in the portable terminal 100.

The cell searching unit 160 supplies the result of the measurement of the power to the cell selecting unit 170. If an appropriate cell is not selected by the cell selecting unit 170, such result is sent back from the cell selecting unit 170 to the cell searching unit, and the power is measured for all of the frequency bands of the corresponding 3G and 2G second network. The resulting measurement for all of the frequency bands is supplied to the cell selecting unit 170 again.

The cell selecting unit 170 receives the information relating to the power level of each cell from the cell searching unit 160, selects a cell having a power level equal to or higher than a preset level, and sends the result to the control unit 140. The preset level is a value that is stored in the cell selecting unit 170 in advance and is a value designated such that the portable terminal 100 may smoothly perform communication in the second network. If a cell having a level equal to or higher than the preset level is not retrieved, the cell selecting unit 170 sends the result back to the cell searching unit 160.

In addition, in a case where there is no cell selected in the selected second network, the cell selecting unit 170 sends such result back to the control unit 140, and the control unit 140 controls the communication mode switching unit 150 to search for a cell in another second network. For example, if the power is measured for all of the frequency bands by the cell searching unit 160 in the 3G network, and there is no cell selected by the cell selecting unit 170, the control unit 140 controls the communication mode switching unit 150 to switch from the 3G network mode to the 2G network mode. After switching to the 2G network mode, the cell searching unit 160 and the cell selecting unit 170 may search for and retrieve a cell that is communicable through the 2G network.

If a cell is selected in the second network, the transmission unit 180 originates a call that has been barred in the first network using the cell in the second network. During the transmission, the transmission unit 180 originates a call differently when the user requests a circuit-switched (CS) call and a packet-switched (PS) call. For example, if the user requests the portable terminal 100 for a phone call, the transmission unit 180 originates the call in the CS mode. On the other hand, if the user requests the portable terminal 100 for the transmission of a message, the transmission unit 180 originates the call in the PS mode.

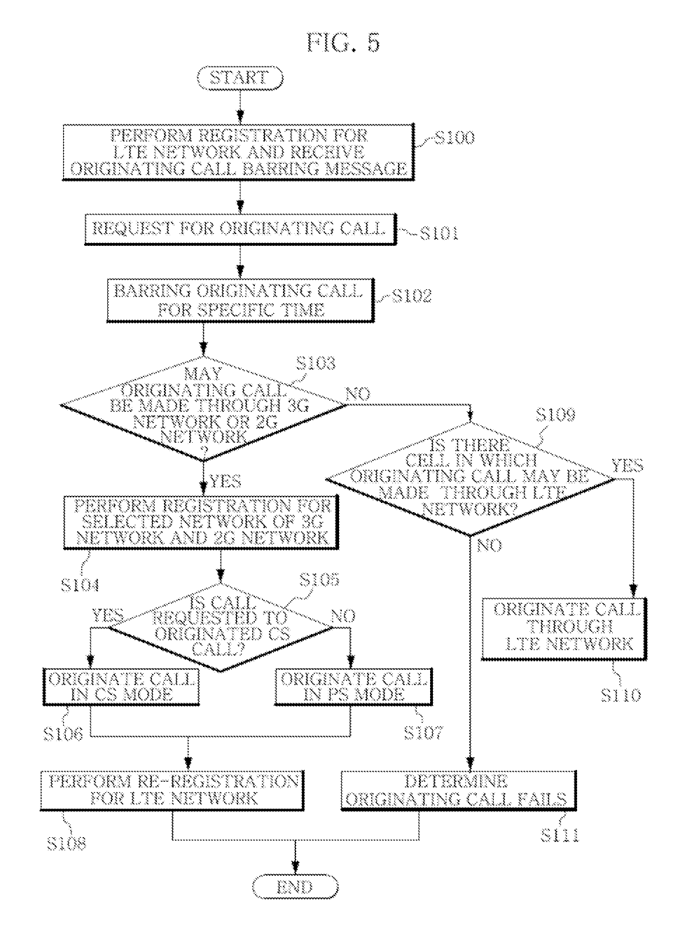

Hereinafter, a method for originating a call through the second network, when originating a call is barred in the first network, according to an exemplary embodiment of the present invention will be described more specifically with reference to FIG. 5.

In operation S100, the portable terminal 100 in FIG. 2 is in the state of being registered in the LTE network and is in a state in which an SIB2 message including an originating call barring message is received. For example, in a case where the portable terminal 100 supports the VoLTE communication method, in a state in which the portable terminal 100 is registered in the IMS, many people may be populated in an area such as a football field or a concert hall. In such a case, since data overload may occur in the corresponding base station, a user may receive a message barring originating a call.

In operation S101, the user inputs a request for originating a call to the portable terminal 100, and, in operation S102, a message indicates that originating a call from the portable terminal 100 is barred for a specific barring time.

Accordingly, in operation S103, the portable terminal 100 determines whether a call may be originated through the second network such as the 3G network or the 2G network. Specifically, the portable terminal 100 searches for a cell communicable in the 3G network or the 2G network and determines that a call may be originated if a communicable cell is retrieved.

In operation S104, if a communicable cell is retrieved in any one of the selected cells in the 3G network and the 2G network, the portable terminal 100 performs a registration process for the selected network.

In operation S105, the transmission unit 180 in FIG. 2 of the portable terminal 100 determines whether the call requested to be originated is a CS call. If the requested call is a CS call, in operation S106 the call is originated in the CS mode. On the other hand, if the requested call is not a CS call, in operation S107 the call is originated in the PS mode.

In operation S108, after originating the call is completed, the control unit 140 in FIG. 2 of the portable terminal 100 is returned to the LTE network and performs re-registration.

However, in operation S103, if a call may not be originated through the 3G network or the 2G network, in operation S109 the portable terminal 100 searches for a cell in which a call may be originated in the LTE network again.

At this time, in operation S110, if there is a cell in which a call may be originated in the LTE network that has been searched again, the portable terminal 100 originates a call through the LTE network. On the other hand, in operation S11, if there is no cell in which a call may be originated, there are no more communication networks for substitution, and a state in which originating a call failed is maintained.

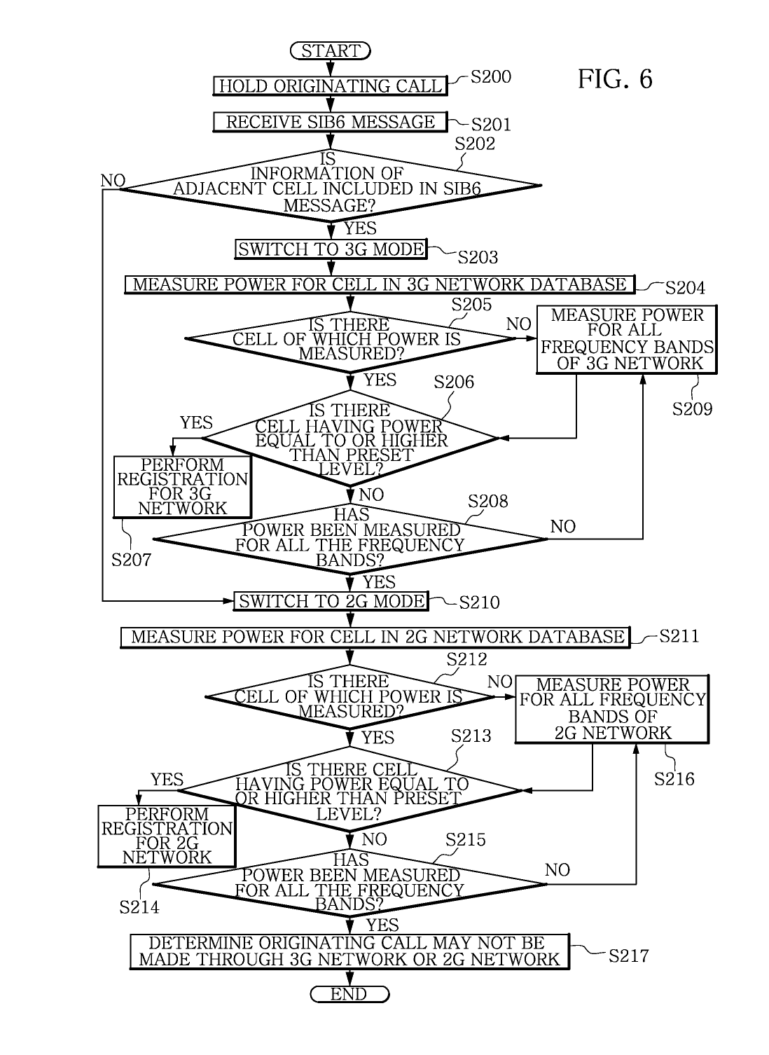

Hereinafter, operation S103 in FIG. 5 is described in more detail with reference to FIG. 6 accordingly to an exemplary embodiment of the present invention.

In operation S200, the portable terminal 100 holds the requested call originated.

The reception unit 110 in FIG. 2 receives an SIB6 message in operation S201 and determines whether information relating to a cell in an area adjacent to the portable terminal 100 is included in the SIB6 message in operation S202.

If information relating to an adjacent cell is included in the SIB6 message, the communication mode switching unit 150 in FIG. 2 switches the LTE mode of the portable terminal 100 to the 3G mode in operation S203.

Thereafter, in operation S204 the cell searching unit 160 in FIG. 2, first, measures the power of the cell stored in the 3G network database by referring to the 3G network database within the storage unit 120.

In operation S205, the cell searching unit 160 provides the cell selecting unit 170 in FIG. 2 with the measurement result, and the cell selecting unit 170 determines whether there is a cell of which the power is measured through the measurement result. If cell information is included in the 3G network database, there is a measured cell. On the other hand, if cell information is not included in the 3G network database, there is no measured cell.

In operation S206, if there is a cell of which the power is measured, the cell selecting unit 170 searches for a cell having a power level that is equal to or higher than a preset level where the preset level, as described above, represents a power level for which communication may be smoothly performed in the 3G network.

In operation S207, among the cells of which the power levels are measured, if there is a cell having a power level equal to or higher than the preset level, the cell selecting unit 170 selects the cell of the 3G network, and the control unit 140 performs 3G network registration through the transmission unit 180.

However, in operation S208, if there is no cell having a power level that is equal to or higher than the preset level, the cell selecting unit 170 sends back the result to the cell searching unit 160, and the cell searching unit 160 determines whether the power measurement has been performed for all frequency bands.

In operation S209, if the power measurement has not been performed for all frequency bands, the cell searching unit 160 measures power for all frequency bands of the 3G network. Thereafter, the cell searching unit 160 provides the cell selecting unit 170 with the measurement result again, and the cell selecting unit 170 goes through operation S206 again.

Meanwhile, if it is determined that there are a plurality of cells having power levels equal to or higher than the preset level, the cell selecting unit 170 may select a cell having a highest power level among the plurality of cells.

In operation S210, if no cell having a power level equal to or higher than the preset level is retrieved through a search in the 3G network through operation S206 and operation S208, the cell selecting unit 170 sends back the result to the control unit 140, and the control unit 140 switches the 3G mode to the 2G mode by controlling the communication mode switching unit 150. In addition, in operation S202, if information relating to an adjacent cell has not been delivered from the SIB6 message, the control unit 140 switches the communication mode of the portable terminal 100 from the LTE mode to the 2G mode.

Thereafter, in operation S211, the cell searching unit 160 measures power for cells included in the 2G network database. Operations 5212 to 5215 performed thereafter are the same as operations 5205 to 5209 described above except that the cells of the 2G network are searched, whereby a cell in which a call may be originated is searched. In other words, if there is a cell having a power level equal to or higher than the preset level among the cells included in the 2G network database or cells included in all frequency bands of the 2G network, the cell selecting unit 170 selects the cell of the 2G network, and the control unit 140 performs 2G network registration through the transmission unit 180.

However, in operation S217, if a cell having a power level equal to or higher than the preset level is not found in the 2G network database or in all frequency bands of the 2G network, the portable terminal 100 fails to originate a call through the 3G network or 2G network. For example, in a case where the portable terminal 100 originates a call in a region in which only the LTE service is supported, even when the power is measured for all the frequency bands of the 2G network or 3G network, a cell in which a call may be originated is not retrieved through a search. In such a case, like in operation S109 illustrated in FIG. 5, the portable terminal 100 returns to the first network, and an LTE cell in which a call may be originated is searched again.

According to an exemplary embodiment of the present invention as described above, as a method for decreasing the data overload phenomenon of an LTE base station in an LTE service in which a voice call is transmitted as data, a call may be originated by switching from the first network in which originating a call is barred to the second network such as the 3G network or the 2G network. Conventionally, if a call may not be originated in the first network, the user tries to originate a call by manually changing the setting of the portable terminal to the second network mode. However, according to an exemplary embodiment of the present invention, a user's convenience in using a portable terminal may be improved by the portable terminal automatically switching between the communication modes when originating a call is barred. In addition, by using the cell information of the database stored in advance in the portable terminal when cells of the second network are searched, the time required for the registration in the second network may be shortened.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable terminal for originating a call, the portable terminal comprising:
a reception unit to receive from a base station a message barring originating a call in a first network;
a storage unit to store a first information, the first information being information of one or more cells of a second network included in a system information block (SIB) message;
an input unit to receive a request to originate a call;
a control unit to select a cell in the storage unit with a power level higher than a preset value if originating the call is barred in the first network; and
a transmission unit to originate the call in the selected cell.

2. The portable terminal of claim 1, wherein the storage unit stores a second information, the second information being information of one or more cells of a second network previously used by the portable terminal.

3. The portable terminal of claim 1, wherein the first network is an LTE network and the second network is one of a 3G network and a 2G network.

4. The portable terminal of claim 2, wherein the storage unit stores the first information and the second information in a second network database, the second network database comprising at least one of a 3G network database and a 2G network database.

5. The portable terminal of claim 4, wherein the control unit comprises:
a communication mode switching unit to switch a communication mode from the first network to a second network if originating the call is barred in the first network;
a cell searching unit to search for cells in the second network database and measure power levels of the searched cells; and
a cell selecting unit to select a searched cell if the power level of the searched cell is higher than the preset value.

6. The portable terminal of claim 5, wherein the cell selecting unit selects a searched cell with the highest power level if the highest power level is higher than the preset value.

7. The portable terminal of claim 6, wherein, if the highest power level is lower than the preset value, the cell searching unit searches for cells of the second network not stored in the second network database, and
the cell selecting unit selects a searched cell of the second network not stored in the second network database if the power level of the searched cell is higher than the preset value.

8. The portable terminal of claim 5, wherein the communication mode switching unit switches from the second network to a different second network if originating the call is barred in the second network.

9. The portable terminal of claim 8, wherein the communication mode switching unit switches the communication mode from the LTE network to the 3G network if originating the call is barred in the LTE network, and
the communication mode switching unit switches the communication mode from the 3G network to the 2G network if originating a call is barred in the 3G network.

10. The portable terminal of claim 1, wherein the transmission unit originates a circuit-switched (CS) call if a voice call is requested and originates a packet-switched (PS) call if a data call is requested.

11. A method to originate a call, the method comprising:
receiving from a base station a message barring originating a call in a first network;
storing a first information, the first information being information of one or more cells of a second network included in a system information block (SIB) message;
receiving a request to originate a call;
selecting a stored cell with a power level higher than a preset value if originating the call is barred in the first network; and
originating the call in the selected cell.

12. The method of claim 11, further comprising storing a second information, the second information being information of one or more cells of a second network previously used by the portable terminal.

13. The method of claim 12, further comprising storing the first information and the second information in a second network database.

14. The method of claim 13, further comprising:
switching a communication mode from the first network to a second network if originating the call is barred in the first network;
searching for cells in the second network database and measuring power levels of the searched cells; and
selecting a searched cell with a power level higher than the preset value.

15. The method of claim 14, further comprising selecting a searched cell with the highest power level if the highest power level is higher than the preset value.

16. The method of claim 15, wherein, if the highest power level is lower than the preset value, searching for cells in the second network not stored in the second network database, and
selecting a searched cell in the second network not stored in the second network database if the power level of the searched cell is higher than a preset value.

17. The method of claim 14, further comprising switching the communication mode from the second network to a different second network if originating the call is barred in the second network.

18. The method of claim 17, further comprising switching the communication mode from the LTE network to the 3G network if originating a call is barred in the LTE network, and
switching the communication mode from the 3G network to the 2G network if originating a call is barred in the 3G network.

19. The method of claim 11, wherein the call is originated as a circuit-switched (CS) call if a voice call is requested and originated as a packet-switched (PS) call if a data call is requested.
